(19) United States
(12) Patent Application Publication
(10) Pub. No.: US 2022/0219030 A1
(43) Pub. Date: Jul. 14, 2022

(54) FIRE SUPPRESSION APPARATUS

(71) Applicant: Ardent Limited, Roecliffe (GB)

(72) Inventors: Matthew Malewski, Roecliffe (GB); Neil Crowther, Roecliffe (GB)

(21) Appl. No.: 17/706,314

(22) Filed: Mar. 28, 2022

Related U.S. Application Data
(63) Continuation of application No. PCT/GB2020/052359, filed on Sep. 29, 2020.

(30) Foreign Application Priority Data
Sep. 30, 2019 (GB) 1914087.0

(51) Int. Cl. A62C 35/02; A62C 99/00

(52) U.S. Cl. CPC A62C 35/023; A62C 3/07; A62C 99/0045

(57) ABSTRACT

A fire suppression apparatus according to an embodiment of the present invention is of a type used particularly in fire suppression systems of vehicles and comprises a container in the form of a pressure cylinder having a discharge valve and, inside the cylinder, a tubular discharge conduit. The cylinder is shown in its operable configuration, arranged on its side, and the discharge tube includes a first portion, close to the valve, that extends substantially parallel with a longitudinal axis of the cylinder, and in this example is substantially central with respect to the cylinder. The tube also includes a second portion that extends downwardly from the substantially axial first portion towards the lowest part of the sidewall of the cylinder and a third portion that is again substantially parallel with the longitudinal axis of the cylinder, but close to the sidewall of the cylinder, at an insert portion.

### CROSS-REFERENCE TO RELATED APPLICATIONS

This application is a continuation of International Application No. PCT/GB2020/052359, filed on Sep. 29, 2020, which claims the priority of United Kingdom Patent Application No. 1914087.0, filed on Sep. 30, 2019, both of which are hereby incorporated by reference in their entireties.

### TECHNICAL FIELD

The present invention relates to a fire suppression apparatus and is concerned more particularly with a fire suppression apparatus that uses a powder agent.

### BACKGROUND

Various kinds of fire suppression apparatus exist, including water, foam and dry powder types. Powder suppression apparatus typically include a vessel, which is usually a cylinder, in which is stored the powder agent and a propellant gas, under super-atmospheric pressure. The powder may be monoammonium phosphate, for example, and the propellant gas is usually nitrogen. In use, a discharge valve is opened (often via an actuator mechanism) and the pressure in the vessel causes the propellant gas and extinguishing powder to exit the vessel via a discharge tube.

In some uses, such as in vehicular fire suppression systems, it may be advantageous to have the cylinder mounted in a horizontal configuration. Horizontal mounting of suppression apparatus is often necessary in order to minimize the space taken up by the apparatus. However, when stored horizontally, as the volume of powder becomes reduced through use and vibration and settling, a remnant quantity of the settled powder eventually lies below an intake opening of the discharge tube. This quantity of powder is no longer usable as it does not become entrained in the gas during discharge. This reduces the effectiveness of the fire suppression apparatus.

### SUMMARY

According to one aspect of the present invention, there is provided a fire suppression apparatus comprising a container for containing a discharge gas under pressure and a fire suppressant agent, a discharge valve and a discharge conduit for conveying gas and agent to the valve in use, wherein the apparatus comprises an agent disturbing portion which is arranged in use to promote the entrainment of agent in the flow of discharge gas during a discharge operation.

The fire suppressant agent may be in powder form.

The agent disturbing portion may comprise one or more apertures in the conduit. The disturbing portion may comprise an end aperture in the conduit and may comprise one or more side apertures in the conduit. In a preferred arrangement, the disturbing portion may comprise a venturi-effect portion.

The disturbing portion may comprise a vortex generating portion of the conduit.

The discharge conduit may comprise a discharge tube.

The discharge conduit preferably includes at least one part that extends substantially parallel with a longitudinal axis of the container, and preferably includes at least one other portion that deviates from parallel with a longitudinal axis of the container. In a preferred arrangement, the deviating portion of the conduit is arranged to extend towards a lower side of the container as mounted in use.

The container is preferably a cylinder.

The discharge valve may be operable in one or more ways to discharge gas and agent including one or more of (but not limited to) mechanical, pneumatic and/or electrical actuation.

The invention also includes a method of improving the discharge efficiency of an agent-based fire suppression system, the method comprising disturbing the agent in a cylinder of the suppression system so that the agent becomes entrained in a discharge gas during a discharge operation.

The invention may include any combination of the features or limitations referred to herein, except such a combination of features as are mutually exclusive, or mutually inconsistent.

Embodiments of the present invention aim to address the problem of incomplete discharge of fire suppression agent, for example when a container of the agent is stored horizontally.

### BRIEF DESCRIPTION OF THE DRAWINGS

A preferred embodiment of the present invention will now be described, by way of example only, with reference to the accompanying diagrammatic drawings, in which:

FIG. 1 is a schematic, longitudinal sectional view of a fire suppression apparatus according to an embodiment of the present invention;

FIG. 2 is schematic, transverse sectional view of the fire suppression apparatus taken along line X-X′ of FIG. 1;

FIG. 3 is a detailed view of area A of FIG. 2; and

FIG. 4 is a detailed view of area B of FIG. 1; and

FIG. 5 is a detailed sectional view of part of the apparatus of FIGS. 1-4.

### DETAILED DESCRIPTION

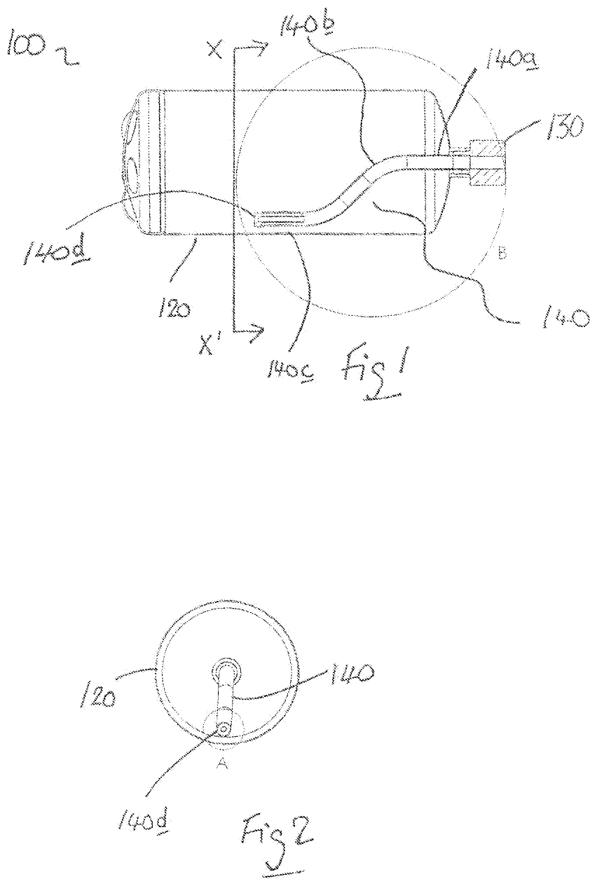

Turning to FIGS. 1 and 2, this shows generally at 100 a fire suppression apparatus according to an embodiment of the present invention. The fire suppression apparatus is of a type used particularly in fire suppression systems of vehicles and comprises a container in the form of a pressure cylinder 120 having a discharge valve 130 and, inside the cylinder, a tubular discharge conduit 140. The cylinder 120 is shown in its operable configuration, arranged on its side, and the discharge tube includes a first portion 140a, close to the valve 130, that extends substantially parallel with a longitudinal axis of the cylinder, and in this example is substantially central with respect to the cylinder. The tube also includes a second portion 140b that extends downwardly from the substantially axial first portion 140a towards the lowest part of the sidewall of the cylinder and a third portion 140c that is again substantially parallel with the longitudinal axis of the cylinder, but close to the sidewall of the cylinder, at an insert portion 140d.

In use, the cylinder 120 contains a propellant gas, such as Nitrogen at a pressure of 24 bar (for example). The cylinder also contains a fire-suppressant agent, such as monoammonium phosphate in powder form (not shown).

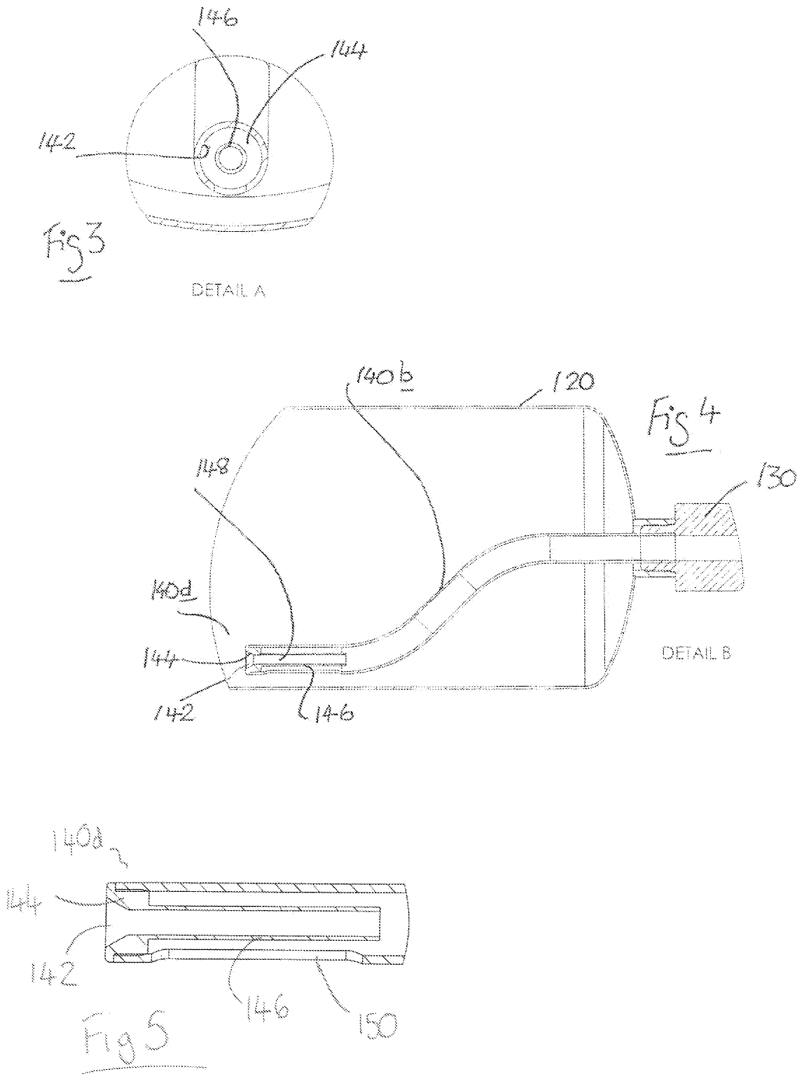

FIGS. 3 and 4 show, respectively, in more detail, the areas A and B of FIGS. 2 and 1 respectively. The insert portion 140d includes an axial end aperture 142 which narrows in a tapered portion 144 to a short inner tube 146, of a smaller diameter than the conduit 140 itself. The insert portion also features a slot 150, which exposes the inner tube 146 to the interior of the cylinder 120. The inner tube 146 is parallel to the cylinder wall 120. The slot 150 is parallel to the inner tube 146 and cylinder wall 120.

FIG. 5 shows in more detail the insert portion 140d.

The shape and juxtaposition of the apertures 142 and 150 are so as to create a venturi portion of the conduit 140. During operation of the suppression apparatus, the effect of this on the pressurized propellant gas is to create a vortex in the cylinder which disturbs a remnant volume of powder agent lying against the bottom of the cylinder. When the powder is disturbed in this way it is much more likely to become entrained in the gas as the gas is released from the cylinder. Further to this, the venturi effect causes a suction effect on the slot 150.

As a result, the quantity of powder agent remaining in the cylinder at a point when the cylinder is no longer usable is considerably lessened. This means that more powder from each charging of the cylinder can be used, leading to a reduction in the frequency of the refilling operations and a consequent saving in cost.

Whilst endeavoring in the foregoing specification to draw attention to those features of the invention believed to be of particular importance, it should be understood that the applicant claims protection in respect of any patentable feature or combination of features referred to herein, and/or shown in the drawings, whether or not particular emphasis has been placed thereon.

What is claimed is:

1. A fire suppression apparatus comprising a container for containing a discharge gas under pressure and a fire suppressant agent, a discharge valve and a discharge conduit for conveying gas and agent to the valve in use, wherein the apparatus comprises an agent disturbing portion which is arranged in use to promote the entrainment of agent in the flow of discharge gas during a discharge operation.

2. A fire suppression apparatus according to claim 1, wherein the fire suppressant agent is in powder form.

3. A fire suppression apparatus according to claim 1, wherein the agent disturbing portion comprises one or more apertures in the conduit.

4. A fire suppression apparatus according to claim 3, wherein the disturbing portion comprises an end aperture in the conduit and one or more side apertures in the conduit.

5. A fire suppression apparatus according to claim 1, wherein the disturbing portion comprises a venturi-effect portion.

6. A fire suppression apparatus according to claim 1, wherein the disturbing portion comprises a vortex generating portion of the conduit.

7. A fire suppression apparatus according to claim 1, wherein the discharge conduit comprises a discharge tube.

8. A fire suppression apparatus according to claim 1, wherein the discharge conduit includes at least one part that extends substantially parallel with a longitudinal axis of the container, and preferably includes at least one other portion that deviates from parallel with a longitudinal axis of the container.

9. A fire suppression apparatus according to claim 8, wherein the deviating portion of the conduit is arranged to extend towards a lower side of the container as mounted in use.

10. A fire suppression apparatus according to claim 1, wherein the container is a cylinder.

11. A fire suppression apparatus according to claim 1, wherein the discharge valve is operable in one or more ways to discharge gas and agent including one or more of mechanical, pneumatic and/or electrical actuation.

12. A method of improving the discharge efficiency of an agent-based fire suppression apparatus, the method comprising disturbing the agent in a cylinder of the suppression apparatus so that the agent becomes entrained in a discharge gas during a discharge operation.
